(19) United States
(12) Patent Application Publication
(10) Pub. No.: US 2023/0029718 A1
(43) Pub. Date: Feb. 2, 2023

(54) METHOD FOR MANUFACTURING SLIDING MEMBER

(71) Applicants: Sumitomo Electric Industries, Ltd., Osaka-shi, Osaka (JP); Sumitomo Electric Fine Polymer, Inc., Sennan-gun, Osaka (JP)

(72) Inventors: Masato BABA, Osaka-shi, Osaka (JP); Hisashi OOGI, Sennan-gun, Osaka (JP); Kouichi KAMIOKA, Sennan-gun, Osaka (JP); Takahiro FUJIMOTO, Sennan-gun, Osaka (JP)

(73) Assignees: Sumitomo Electric Industries, Ltd., Osaka-shi, Osaka (JP); Sumitomo Electric Fine Polymer, Inc., Sennan-gun, Osaka (JP)

(21) Appl. No.: 17/784,130

(22) PCT Filed: Nov. 20, 2020
(86) PCT No.: PCT/JP2020/043417

§ 371 Date: Jun. 10, 2022

(30) Foreign Application Priority Data
Dec. 13, 2019 (JP) 2019-225660

(51) Int. Cl. C08L 23/08; F16C 33/14; F16C 33/20; C08J 7/12

(52) U.S. Cl. CPC C08L 23/0892; F16C 33/14; F16C 33/20; C08J 7/123; C08J 2327/18

(57) ABSTRACT

A method for manufacturing a sliding member according to one aspect of the present disclosure is a method for manufacturing a sliding member containing an ethylene-tetrafluoroethylene copolymer as a main component, and comprises processing a material containing an ethylene-tetrafluoroethylene copolymer as a main component, and irradiating a processed body obtained in the processing step with an electron beam.

### TECHNICAL FIELD

The present invention relates to a method for manufacturing a sliding member, and a sliding member.

The present application claims priority based on Japanese Patent Application No. 2019-225660, filed on Dec. 13, 2019, the entire contents of which are hereby incorporated by reference.

### BACKGROUND ART

Sliding members are used, for example, for bearings for automotive engines and engines for other industrial machines, and driving parts, piston packings and the like in the automobile field. As such a sliding member, a sliding member including fluororesin, particularly polytetrafluoroethylene (PTFE), as its surface layer is well known (see Japanese Patent Laying-Open No. 2018-185007). By using PTFE, the dynamic friction coefficient against a mating material is reduced while the wear resistance is retained, and the sliding member can have excellent mechanical strength, chemical resistance, high lubricity, heat resistance, weather resistance, nonflammability and the like. That is, a sliding member using PTFE is excellent in slidability.

The sliding member can be manufactured by layering a material containing PTFE as a main component on a base material, for example, by extrusion, and irradiating the material with an electron beam in an oxygen-free atmosphere and a melt state.

### CITATION LIST

### Patent Literature

PTL 1: Japanese Patent Laying-Open No. 2018-185007

### SUMMARY OF INVENTION

A method for manufacturing a sliding member according to one aspect of the present disclosure is a method for manufacturing a sliding member containing an ethylene-tetrafluoroethylene copolymer as a main component, and comprises processing a material containing an ethylene-tetrafluoroethylene copolymer as a main component, and irradiating a processed body obtained in the above processing with an electron beam.

A sliding member according to another aspect of the present disclosure is a sliding member containing an ethylene-tetrafluoroethylene copolymer as a main component, wherein the ethylene-tetrafluoroethylene copolymer is crosslinked by irradiation with an electron beam.

### BRIEF DESCRIPTION OF DRAWINGS

FIG. 1 is a schematic flow diagram illustrating a method for manufacturing a sliding member according to one aspect of the present disclosure.

FIG. 2 is a schematic side view illustrating a procedure to obtain processed bodies in Examples.

FIG. 3 is one example of a DSC curve of an ethylene-tetrafluoroethylene copolymer.

### DETAILED DESCRIPTION

[Problem to be Solved by the Present Disclosure]

Sliding members using PTFE are suitably crosslinked by being irradiated with an electron beam in an oxygen-free atmosphere and in a melt state to develop their excellent characteristics. Thus, in the case of manufacturing the conventional sliding members using PTFE, there is room for improvement in their manufacturing efficiency from the viewpoint of facilities to make the oxygen-free atmosphere and melt state, and the energy and time required.

The present disclosure has been achieved based on the above-mentioned situation, and an object is to provide a method for manufacturing a sliding member which is excellent in slidability and can raise the manufacturing efficiency, and the sliding member.

[Advantageous Effects of the Present Disclosure]

The method for manufacturing a sliding member according to the present disclosure and the sliding member according to the present disclosure are excellent in the slidability and can raise the manufacturing efficiency.

[Description of Embodiments]

The present inventors have found that by using an ethylene-tetrafluoroethylene copolymer (ETFE) obtained by polymerization of ethylene and tetrafluoroethylene in place of a polytetrafloroethylene (PTFE) obtained by polymerization of tetrafluoroethylene, a sliding member excellent in slidability can be obtained even without placing the ethylene-tetrafluoroethylene copolymer in an oxygen-free atmosphere and a melt state in irradiation with an electron beam, and have completed the present invention.

That is, a method for manufacturing a sliding member according to one aspect of the present disclosure is a method for manufacturing a sliding member containing an ethylene-tetrafluoroethylene copolymer as a main component, and comprises processing a material containing an ethylene-tetrafluoroethylene copolymer as a main component, and

irradiating a processed body obtained in the processing step with an electron beam.

The method for manufacturing a sliding member, which employs an ethylene-tetrafluoroethylene copolymer that is a fluororesin as a main component of the sliding member, can provide a sliding member excellent in slidability. Further, the method for manufacturing a sliding member does not require for placing the processed body in an oxygen-free atmosphere and a melt state in irradiation with an electron beam, which can raise the manufacturing efficiency.

The irradiation dose of an electron beam in the irradiation with an electron beam is preferably no less than 200 kGy. With the irradiation dose of an electron beam being no less than the lower limit, the slidability of a sliding member to be obtained can more securely be improved.

The irradiation dose of an electron beam in the irradiation with an electron beam is preferably no more than 350 kGy. With the irradiation dose of an electron beam being no more than the upper limit, the mechanical strength of a sliding member to be obtained can easily be secured.

It is preferable that the conditions of the irradiation with an electron beam is not an oxygen-free atmosphere and the processed body is not in a melt state. By carrying out the irradiation with an electron beam thus under the conditions of not an oxygen-free atmosphere and not a melt state, the manufacturing efficiency can be raised more securely.

It is preferable that the atmospheric temperature in the irradiation with an electron beam is normal temperature. With the atmospheric temperature being normal temperature, a facility and the energy for heating or cooling are not required, which can further raise the manufacturing efficiency can further be raised.

It is preferable that the atmosphere in the irradiation with an electron beam is air. With the atmosphere being air, a facility and the energy for adjusting the atmosphere are not required, which can further raise the manufacturing efficiency.

It is preferable that a processing method in the processing step is injection molding. By thus using injection molding as a processing method in the processing step, a processed body can previously be made into a desired shape of a sliding member. Hence, processing or adjustment to the desired shape is not required after the irradiation with an electron beam, which can raise the manufacturing efficiency.

A sliding member according to another aspect of the present disclosure is a sliding member containing an ethylene-tetrafluoroethylene copolymer as a main component, wherein the ethylene-tetrafluoroethylene copolymer is crosslinked by irradiation with an electron beam.

The sliding member, which contains an ethylene-tetrafluoroethylene copolymer as a main component, has a high manufacturing efficiency. Further, the sliding member is excellent in slidability since the ethylene-tetrafluoroethylene copolymer is crosslinked by irradiation with an electron beam.

An endothermic curve peak of the ethylene-tetrafluoroethylene copolymer is present on a DSC curve by differential scanning calorimetry; and the endothermic curve peak is shifted to a low-temperature side relative to an endothermic curve peak of an uncrosslinked ethylene-tetrafluoroethylene copolymer; and the temperature shift is preferably no less than 11° C. and no more than 20° C. With the temperature shift being within the above range, the slidability can be raised while the mechanical strength of the sliding member is secured.

The ratio of an endothermic quantity of the ethylene-tetrafluoroethylene copolymer to an endothermic quantity of the uncrosslinked ethylene-tetrafluoroethylene copolymer as determined by a DSC curve by differential scanning calorimetry is preferably no less than 0.8 and no more than 0.9. With the ratio of the endothermic quantity being within the above range, the slidability can be raised while the mechanical strength of the sliding member is secured.

Here, the “main component” refers to a component having the highest content, and refers, for example, to a component having a content of no less than 50% by mass. The “normal temperature” refers to natural temperatures not accompanied by heating or cooling, and usually refers to a temperature of no less than 15° C. and no more than 35° C.

The “endothermic curve peak on a DSC curve determined by differential scanning calorimetry” refers to a temperature (P in FIG. 3) at which the absolute value of the endothermic quantity becomes maximum on the DSC curve. The “endothermic quantity as determined by a DSC curve”, as shown in FIG. 3, corresponds to an area S surrounded by the DSC curve and a base line BL in the region of the endothermic curve peak. The “uncrosslinked ethylene-tetrafluoroethylene copolymer” can be recovered from the ethylene-tetrafluoroethylene copolymer irradiated with an electron beam by dissolving it in a solvent.

[Details of Embodiments of the Present Disclosure]

Hereinafter, embodiments of the method for manufacturing a sliding member, and the sliding member according to the present invention will be described in detail by reference to the drawings.

[Method for Manufacturing a Sliding Member]

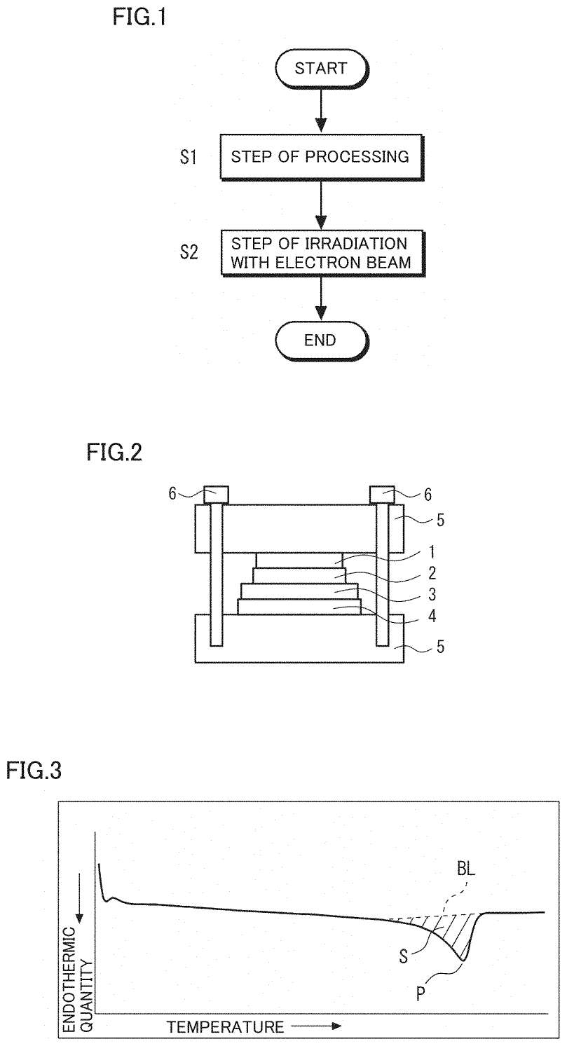

The method for manufacturing a sliding member according to one aspect of the present disclosure is a method for manufacturing a sliding member containing an ethylene-tetrafluoroethylene copolymer as a main component. The method for manufacturing a sliding member comprises a step S1 of processing a material containing an ethylene-tetrafluoroethylene copolymer as a main component and a step S2 of irradiating a processed body obtained in the processing step S1 with an electron beam as illustrated in FIG. 1.

<Processing Step>

In the processing step S1, a material containing an ethylene-tetrafluoroethylene copolymer as a main component is processed as described above.

The ethylene-tetrafluoroethylene copolymer (ETFE) being a main component of the material is a fluororesin in which ethylene (C₂H₄) and tetrafluoroethylene (C₂F₄) are polymerized. ETFE is superior in the mechanical strength and the chemical resistance even to PTFE.

The lower limit of the content of ETFE in the material is, with respect to the processed body, preferably 60% by mass, more preferably 85% by mass and still more preferably 98% by mass. Further, it is especially preferable that the content of the ETFE is 100% by mass, that is, the processed body is composed of ETFE alone. When the content of the ETFE is less than the above lower limit, the slidability of a sliding member to be obtained might be deteriorated.

ETFE may contain polymerization units originated from other copolymerizable monomers in the range of not impairing the advantageous effects of the present invention. Examples of the polymerization units include perfluoro(alkyl vinyl ether), hexafluoropropylene, (perfluoroalkyl)ethylene and chlorotrifluoroethylene. The upper limit of the content proportion of the polymerization units can be, for example, 3% by mol.

The material may contain other optional components. Examples of the optional components include solid lubricants and reinforcing agents. By thus containing a solid lubricant, a reinforcing agent and the like, the high lubricity can be improved. Examples of the solid lubricant include molybdenum disulfide. Examples of the reinforcing agent include glass fibers, glass fillers such as spherical glasses, carbon fibers, and inorganic fillers of calcium carbonate, talc, silica, alumina, aluminum hydroxide and the like.

A method of processing the material is not particularly limited, and powder coating, welding and adhesion to base materials, and the like can be used besides well-known extrusion or injection molding.

It is preferable that a processing method in the processing step S1 is injection molding. Conventional sliding members using PTFE are placed in a melt state in manufacture and are therefore easily deformed. In order to suppress the deformation, the conventional sliding members are manufactured by layering PTFE on the surface of a base material. Hence, it is difficult to constitute sliding members only of a material containing PTFE as a main component by injection molding. By contrast, the method for manufacturing a sliding member uses ETFE as a main component, and therefore the processed body is not required to be placed in a melt state in manufacture, which is less likely to lead to the deformation of the processed body. Therefore, in the method for manufacturing a sliding member, the processed body can be previously formed into a desired shape of a part as a sliding member. Further, the deformation in the irradiation with an electron beam can be suppressed in the method for manufacturing a sliding member, and therefore processing or adjusting the shape to a desired shape after the irradiation with an electron beam is not required, which can further raise manufacturing efficiency.

With regard to the shape of the processed body obtained in the processing step S1, although the shape including shapes of parts and piece goods to be used as sliding members is suitably selected according to applications and processing methods of the sliding members to be obtained, it is preferable that the shape of the processed body is a shape of a part, from the viewpoint of the manufacturing efficiency as described above.

The processed body may be a simple body constituted only of a material containing ETFE as a main component, or may also be a stack constituted by stacking a surface layer containing ETFE on the surface of a base material. In the case of the processed body being a stack, there can be used a metal, a ceramic, a rubber material, a heat-resistant resin or the like as the base material. Examples of the metal include aluminum, iron, copper and stainless steel. Examples of the ceramic include aluminum oxide, silicon nitride, silicon carbide and tungsten carbide. Examples of the rubber material include fluororubber, silicone rubber and thermoplastic elastomer. Examples of the heat-resistant resin include polyimide resins, polyamideimide resins, polyetheretherketone resins. The surface layer can be constituted of the above-mentioned material containing ETFE as a main component. Here, the surface layer may cover the whole base material, or may be stacked on part thereof.

<Irradiation with an Electron Beam>

In the step S2 of irradiation with an electron beam, the processed body obtained in the processing step S1 as described above is irradiated with an electron beam.

An electron beam is irradiated to ETFE constituting the processed body. The irradiation with an electron beam progresses crosslinking of ETFE and the slidability of a sliding member to be obtained is thereby raised.

The conditions of the irradiation with an electron beam is not an oxygen-free atmosphere and the processed body is not in a melt state. With the irradiation with an electron beam being carried out under such conditions of not an oxygen-free atmosphere and not a melt state, a facility, the energy and the time for making the oxygen-free atmosphere and the melt state can be reduced, which can raise the manufacturing efficiency more securely.

It is especially preferable that the atmospheric temperature in the step S2 of irradiation with an electron beam is normal temperature. With the atmospheric temperature being normal temperature, a facility and the energy for heating or cooling are not required. Further, since the deformation of the processed body by heat can be suppressed, adjusting the shape of the processed body after the irradiation with an electron beam is not required. Hence, the manufacturing efficiency of the method for manufacturing a sliding member can further be raised.

It is preferable that the atmosphere in the irradiation with an electron beam is air. With the atmosphere being air, a facility and the energy for adjusting the atmosphere are not required, which can further raise the manufacturing efficiency.

The lower limit of the irradiation dose of an electron beam in the step S2 of irradiation with an electron beam is preferably 200 kGy, more preferably 220 kGy and still more preferably 240 kGy. On the other hand, the upper limit of the irradiation dose of an electron beam is preferably 350 kGy and more preferably 320 kGy. When the irradiation dose of an electron beam is less than the lower limit, the slidability of a sliding member to be obtained might not sufficiently be improved. Conversely, when the irradiation dose of an electron beam is more than the upper limit, the mechanical strength of a sliding member to be obtained might be lowered.

In the case where the shape of the processed body obtained in the processing step S1 is a shape of a part to be used as a sliding member, and the conditions of irradiation with an electron beam in the step S2 of irradiation with an electron beam is not a melt state, the desired sliding member can be obtained by the irradiation with an electron beam. By contrast, in the cases other than the above case, processing or adjusting to a desired shape is carried out as required after the irradiation with an electron beam.

<Advantages>

The method for manufacturing a sliding member, which employs an ethylene-tetrafluoroethylene copolymer that is a fluororesin as a main component of the sliding member, can provide a sliding member excellent in slidability. Further, the method for manufacturing a sliding member does not require an oxygen-free atmosphere and a melt state in the irradiation with an electron beam, which can raise the manufacturing efficiency.

[Sliding Member]

The sliding member according to another aspect of the present invention is a sliding member containing an ethylene-tetrafluoroethylene copolymer as a main component. In the sliding member, the ethylene-tetrafluoroethylene copolymer is crosslinked by irradiation with an electron beam.

The sliding member is used, for example, for bearings for automotive engines and engines for other industrial machines, and driving parts, piston packings and the like in the automobile field. The sliding member can be manufactured by using, for example, the above-mentioned method for manufacturing a sliding member of the present invention.

The sliding member may be a simple body constituted only of a material containing an ethylene-tetrafluoroethylene copolymer (ETFE) as a main component, or may also be a stack constituted by stacking a surface layer containing ETFE on the surface of a base material. In the case where the sliding member is not a stack but a simple body, the material containing ETFE as a main component can be a material obtained by solidifying the material described in the above-mentioned method for manufacturing a sliding member. In the case of the sliding member being a stack, a base material and a surface layer can be, respectively, the base material and the surface layer described in the above-mentioned method for manufacturing a sliding member.

The lower limit of the limit PV value of the sliding member is preferably 500 MPa·m/min and more preferably 700 MPa·m/min. When the limit PV value is less than the lower limit, the slidability of the sliding member might become insufficient. On the other hand, the upper limit of the limit PV value is not particularly limited, and can be, for example, 3,000 MPa·m/min. The “limit PV value” is a product of an interplanar contact pressure (P) and a velocity (V), and is a value measured according to JIS K7216:1986, “Testing Methods for Sliding Wear Resistance of Plastics”. In the condition near the limit PV value, the friction coefficient and the wear amount both become large and it becomes difficult for the material to retain its function. Hence, the limit PV value is used as an index to judge the slidability of a sliding member. Note that the measurement conditions of the limit PV value are: making a mating material to have a surface roughness Ra of 0.28 μm based on JIS B0601:2001, and fixing the interplanar contact pressure (P) at 10 MPa, and varying the velocity. With regard to a test piece of a sliding member, used is one in which an ETFE film having a square shape with 50 mm sides and a thickness of 50 μm welded onto a cold rolled steel sheet (SPCC material) base material having a square shape with 45 mm sides and having a thickness of 4.5 mm.

The upper limit of the dynamic friction coefficient of the sliding member is preferably 0.15 and more preferably 0.1. When the dynamic friction coefficient is more than the upper limit, the slidability of the sliding member might become insufficient. The lower limit of the dynamic friction coefficient of the sliding member is not particularly limited, and may also be 0.

When the sliding member is subjected to differential scanning calorimetry, an endothermic curve peak of the ethylene-tetrafluoroethylene copolymer is present on a DSC curve (see FIG. 3). The endothermic curve peak is shifted to a low-temperature side relative to an endothermic curve peak of an uncrosslinked ethylene-tetrafluoroethylene copolymer. The lower limit of the temperature shift is preferably 11° C., more preferably 12° C. and still more preferably 13° C. On the other hand, the upper limit of the temperature shift is preferably 20° C. and more preferably 18° C. When the temperature shift is less than the lower limit, the slidability might become insufficient. Conversely, when the temperature shift is more than the upper limit, the mechanical strength might be lowered.

The lower limit of the ratio of an endothermic quantity of the ethylene-tetrafluoroethylene copolymer to an endothermic quantity of the uncrosslinked ethylene-tetrafluoroethylene copolymer as determined by a DSC curve by differential scanning calorimetry is preferably 0.8 and more preferably 0.83. On the other hand, the upper limit of the ratio of the endothermic quantities is preferably 0.9, more preferably 0.89 and still more preferably 0.88. When the ratio of the endothermic quantities is less than the lower limit, the mechanical strength might be lowered. On the other hand, when the ratio of the endothermic quantities is more than the upper limit, the slidability might become insufficient.

<Advantages>

The sliding member, which contains an ethylene-tetrafluoroethylene copolymer as a main component, has a high manufacturing efficiency. Further, the sliding member is excellent in the slidability since the ethylene-tetrafluoroethylene copolymer is crosslinked by irradiation with an electron beam.

[Other Embodiments]

It should be understood that embodiments disclosed herein are exemplifications and are not restrictive in all respects. The scope of the present disclosure is not limited to the constitutions in the embodiments, and it is intended to cover all modifications indicated by the claims and in the meaning and the scope of equivalents to the claims.

In the above embodiments, although the cases have been described where the conditions of the irradiation with an electron beam in the irradiation with an electron beam is not an oxygen-free atmosphere and is a processed body not being in a melt state, the condition can also be an oxygen-free atmosphere and a melt state. Alternatively, the condition can be conditions of being an oxygen-free atmosphere but not being a melt state, or conversely, conditions of not being an oxygen-free atmosphere but being a melt state.

### EXAMPLES

Hereinafter, the method for manufacturing a sliding member and the sliding member of the present disclosure will be described specifically based on Examples, but the present disclosure is not limited to these Examples.

[No. 1]

As illustrated in FIG. 2, a base material 1 of a cold rolled steel sheet (SPCC material) and an ETFE film 2 were superposed. Base material had a square shape with 45 mm sides and a thickness of 4.5 mm, and ETFE film had a square shape with 50 mm sides and a thickness of 50 μm. Further a strip-shape PTFE film 3 and a strip-shape SUS sheet 4 were superposed on the surface of ETFE film 2, and wholly interposed between a pair of welding jigs 5 so that the jigs contacted with base material 1 and SUS sheet 4. In this state, the pair of welding jigs 5 was fastened with a pair of screws 6, as illustrated in FIG. 2, to tighten screws 6 so as to make a pressure-welding force of 3 N·m between base material 1 and ETFE film 2.

After welding jigs 5 were fixed as described above, the resultant was held at a temperature of 300° C. for 1.5 hours to weld ETFE film 2 to base material 1. Then, welding jigs 5, PTFE film 3 and SUS sheet 4 were detached to obtain a processed body in which ETFE film 2 was stacked on the surface of base material 1. In No. 1, the processed body was used as a sliding member. That is, No. 1 was an uncrosslinked ETFE film-welded iron sheet.

[No. 2 to No. 13]

Processed bodies were obtained as in No. 1. ETFE films 2 of the processed bodies were each irradiated with an irradiation dose of an electron beam indicated in Table 1. The conditions of the irradiation with an electron beam was the air atmosphere and the normal temperature not accompanied by heating or cooling. Sliding members of No. 2 to No. 13 were thus obtained. No. 2 to No. 13 were crosslinked ETFE film-welded iron sheets.

<Evaluation Methods>

The obtained sliding members of No. 1 to No. 13 were evaluated for the limit PV, the tensile strength, the tensile elongation, the tensile elastic modulus, the tear strength and the dynamic friction coefficient. Evaluation methods are shown in the below. Respective evaluation results are shown in Table 1.

(Limit PV)

The measurement of the limit PV was carried out according to JIS K7218:1986, “Testing Methods for Sliding Wear Resistance of Plastics” by using a ring-on-disc type friction and wear tester (manufactured by A&D Co., Ltd., EFM-III 1010). As a ring-shape mating material, a cylinder (outer diameter: 11.6 mm, inner diameter: 7.4 mm) composed of a material of S45C was used, and the surface roughness based on JIS B0601:2001 was 0.28 μm. The test condition was: a dry state (oilless), holding the pressure at a constant value of 10 MPa and raising the velocity.

(Tensile Strength, Tensile Elongation and Tensile Elastic Modulus)

The measurements of the tensile strength, the tensile elongation and the tensile elastic modulus were carried out based on JIS K7161-1:2014, “Plastics—Determination of tensile properties—Part 1 General principles”.

(Tear Strength)

The measurement of the tear strength was carried out based on JIS K7128-1:1998, “Plastics—Film and sheeting—Determination of tear resistance”.

(Dynamic Friction Coefficient)

The dynamic friction coefficient was determined by measuring the reaction torque generated on the cylinder as the ring-shape mating material in the measurement of the limit PV.

TABLE 1

| | | | | | Tensile | | Dynamic |
|---|---|---|---|---|---|---|---|
| | | | Tensile | Tensile | elastic | Tear | friction |
| | Irradiation | Limit PV | strength | elongation | modulus | strength | coefficient |
| | dose (kGy) | (MPa · m/min) | (N/mm²) | (%) | (N/mm²) | (N/mm) | μ |
| No. 1 | 0 | 100 | 57.00 | 459.60 | 932.80 | 58.60 | 0.199 |
| No. 2 | 40 | 200 | 48.21 | 363.33 | 1102.41 | 47.20 | 0.182 |
| No. 3 | 80 | 200 | 47.78 | 369.78 | 866.05 | 17.78 | 0.159 |
| No. 4 | 120 | 400 | 34.63 | 211.08 | 1081.08 | 7.39 | 0.111 |
| No. 5 | 160 | 400 | 36.88 | 235.39 | 1309.15 | 5.72 | 0.092 |
| No. 6 | 200 | 700 | 32.43 | 190.58 | 1152.98 | 6.37 | 0.076 |
| No. 7 | 240 | 900 | 33.42 | 198.89 | 1125.73 | 5.96 | 0.069 |
| No. 8 | 280 | 1100 | 39.21 | 214.72 | 740.66 | 5.41 | 0.085 |
| No. 9 | 320 | 1200 | 36.50 | 192.17 | 803.04 | 4.52 | 0.057 |
| No. 10 | 360 | 100 | 33.76 | 168.28 | 778.45 | 4.50 | 0.227 |
| No. 11 | 400 | 100 | 30.73 | 146.03 | 1388.22 | 3.91 | 0.245 |
| No. 12 | 800 | 100 | 26.27 | 44.61 | 1034.24 | 2.04 | 0.136 |
| No. 13 | 1200 | 100 | 26.32 | 12.69 | 1150.48 | 1.32 | 0.290 |

From the results in Table 1, it is clear that by using the ethylene-tetrafluoroethylene copolymer as the main component, even when the irradiation with an electron beam is carried out under the conditions of not an oxygen-free atmosphere and the processed body not being in a melt state, the sliding members which have a high limit PV, and a low dynamic friction coefficient, and are excellent in the slidability can be obtained.

Furthermore, particularly in the sliding members of No. 6 to No. 9, which had an irradiation dose of the irradiation with an electron beam of no less than 200 kGy and no more than 350 kGy, the limit PV is high and the mechanical strength including the tensile strength hardly lowers. Therefore, it is clear that by making the irradiation dose of the irradiation with an electron beam within the above range, while the mechanical strength of the sliding members are secured, the slidability can be raised.

### REFERENCE SIGNS LIST

1 Base Material
2 ETFE Film
3 PTFE Film
4 SUS Sheet
5 Welding Jig
6 Screw
P Peak
BL Base Line
S Area (Endothermic Quantity)

1. A method for manufacturing a sliding member containing an ethylene-tetrafluoroethylene copolymer as a main component, the method comprising:
processing a material containing an ethylene-tetrafluoroethylene copolymer as a main component; and
irradiating a processed body obtained in the processing with an electron beam, wherein
conditions of the irradiation with an electron beam is not a melt state.

2. The method for manufacturing a sliding member according to claim 1, wherein an irradiation dose of an electron beam in the irradiation with an electron beam is no less than 200 kGy.

3. The method for manufacturing a sliding member according to claim 2, wherein the irradiation dose of an electron beam in the irradiation with an electron beam is no more than 350 kGy.

4. The method for manufacturing a sliding member according to claim 1, wherein conditions of the irradiation with an electron beam is not an oxygen-free atmosphere.

5. The method for manufacturing a sliding member according to claim 4, wherein an atmospheric temperature in the irradiation with an electron beam is normal temperature.

6. The method for manufacturing a sliding member according to claim 4, wherein an atmosphere in the irradiation with an electron beam is air.

7. The method for manufacturing a sliding member according to claim 1, wherein a processing method in the processing is injection molding.

8-10. (canceled)
